(19) United States
(12) Patent Application Publication
(10) Pub. No.: US 2016/0169398 A1
(43) Pub. Date: Jun. 16, 2016

(54) VALVE DEVICE FOR FUEL VAPOR SYSTEM

(71) Applicant: KYOSAN DENKI CO., LTD., Koga City (JP)

(72) Inventors: Tetsuya TAKAHASHI, Shimotsuke-shi (JP); Akihiro KIMURA, Bandou-shi (JP)

(73) Assignee: KYOSAN DENKI CO., LTD., Koga City (JP)

(21) Appl. No.: 14/965,556

(22) Filed: Dec. 10, 2015

(30) Foreign Application Priority Data
Dec. 15, 2014 (JP) 2014-253383

(51) Int. Cl. F16K 17/04; B60K 15/035; F16K 15/14

(52) U.S. Cl. CPC F16K 17/0453; F16K 15/148; B60K 15/03519; B60K 2015/03296

(57) ABSTRACT

A valve device for a fuel vapor system includes: a case having a valve seat; and an umbrella valve having a valve portion that provides a valve closed state by contacting the valve seat and provides a valve open state by separating from the valve seat, and an outer edge portion that is formed on a radially outer side of the valve portion and restrained by the case. The valve portion is elastically deformed so as to be convex by a predetermined amount in one direction in an axial direction in the valve closed state; and the valve portion is elastically deformed so as to be convex by greater than the predetermined amount in the one direction in the valve open state.

### INCORPORATION BY REFERENCE

The disclosure of Japanese Patent Application No. 2014-253383 filed on Dec. 15, 2014 including the specification, drawings and abstract is incorporated herein by reference in its entirety.

### BACKGROUND OF THE INVENTION

1. Field of the Invention

The invention disclosed herein relates to a valve device for a fuel vapor system, which is disposed in a passage for fuel vapor to flow through.

2. Description of Related Art

Japanese Patent Application Publication No. 2008-202635 (JP 2008-202635 A) and Japanese Patent Application Publication No. 2013-177108 (JP 2013-177108 A) disclose a valve device disposed in a ventilation passage for a fuel tank. JP 2008-202635 A discloses a valve body having an elastically deformable flange portion. This valve body opens and closes the passage in such a way that the entire valve body including the flange portion is moved axially. JP 2013-177108 A discloses a valve body having rubber elasticity. This valve body is fixed at its outer edge and is shifted to a valve closed position or a valve open position by the elasticity of the valve body itself and the pressure difference thereacross.

### SUMMARY OF THE INVENTION

In the valve device of JP 2008-202635 A, the valve body is slightly movable radially in order to allow the axial movement of the valve body. Further, the valve body may be slightly inclined. Therefore, there are cases where the state of contact between the valve body and a valve seat is not stable. For example, the radial movement of the valve body causes a movement of a contact position between the valve body and the valve seat. Further, the inclination of the valve body may impair the sealing at a portion of the valve seat. From this point of view, with the valve device of JP 2008-202635 A, it is difficult to prevent leakage in the valve closed position.

Further, in the valve device of JP 2008-202635 A, the valve body may be vibratingly moved while the valve body is separated from the valve seat. Such vibrating movement is not desirable from various aspects such as noise, flow rate stability, and durability.

In the valve device of JP 2013-177108 A, the valve body is seated on a valve seat solely by the elasticity of the valve body itself. Therefore, it is difficult to make sufficiently large a force to press the valve body against the valve seat. The valve body of JP 2013-177108 A has a cross-sectional shape that can be called an M-shape. Consequently, a central portion, in contact with the valve seat, of the valve body may be slightly moved radially. Such a movement may impair stable contact between the valve body and the valve seat. From this point of view, even with the valve device of JP 2013-177108 A, it is difficult to prevent leakage in the valve closed position.

From the above-mentioned points of view and from other points of view not mentioned above, a valve device for a fuel vapor system is required to be further improved.

It is an object of the invention to provide a valve device for a fuel vapor system that can suppress leakage in a valve closed position.

It is another object of the invention to provide a valve device for a fuel vapor system that can suppress radial movement of a valve body.

It is still another object of the invention to provide a valve device for a fuel vapor system that can ensure reliable contact between a valve body and a valve seat in a valve closed position while suppressing vibration behavior of the valve body in a valve open position.

A symbol in parentheses described in the claims and this section shows the correspondence with a specific means in an embodiment which will be described later as one aspect, and does not limit the technical scope of the invention.

According to an aspect of the invention, a valve device, disposed in a passage for a gas containing fuel vapor to flow through, for a fuel vapor system includes: a case having a valve seat; and an umbrella valve having a valve portion that is elastically deformable in an axial direction, provides a valve closed state by contacting the valve seat, and provides a valve open state by separating from the valve seat, and an outer edge portion that is formed on a radially outer side of the valve portion and restrained by the case. The valve portion is elastically deformed so as to be convex by a predetermined amount in one direction in the axial direction in the valve closed state; and the valve portion is elastically deformed so as to be convex by greater than the predetermined amount in the one direction in the valve open state.

According to the aspect described above, the umbrella valve is restrained at the outer edge portion. Therefore, radial movement of the valve portion is limited. The position of the valve portion is stabilized. In the valve closed state, the valve portion is elastically deformed so as to be convex by the predetermined amount in the one direction. This enables reliable contact between the valve portion and the valve seat. In the valve open state, the valve portion is elastically deformed so as to be convex by greater than the predetermined amount. This makes it possible to suppress vibration behavior of the valve portion by its own elasticity.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a block diagram of a fuel supply system for a vehicle according to a first embodiment of the invention;

FIG. 2 is a sectional view of a valve device of the first embodiment;

FIG. 3 is a sectional view of the valve device of the first embodiment;

FIG. 4 is a sectional view showing a movable valve of the first embodiment; and

FIG. 5 is an enlarged partial sectional view showing the valve device of the first embodiment.

### DETAILED DESCRIPTION OF EMBODIMENTS

Referring to the drawings, a plurality of modes for carrying out the invention disclosed herein will be described. In each mode, there are cases where the same reference symbols are assigned to portions corresponding to those described in the previous mode, thereby omitting overlapping description. In each mode, if only a portion of the configuration is described, a description of the other mode can be referred to and applied for other portions of the configuration.

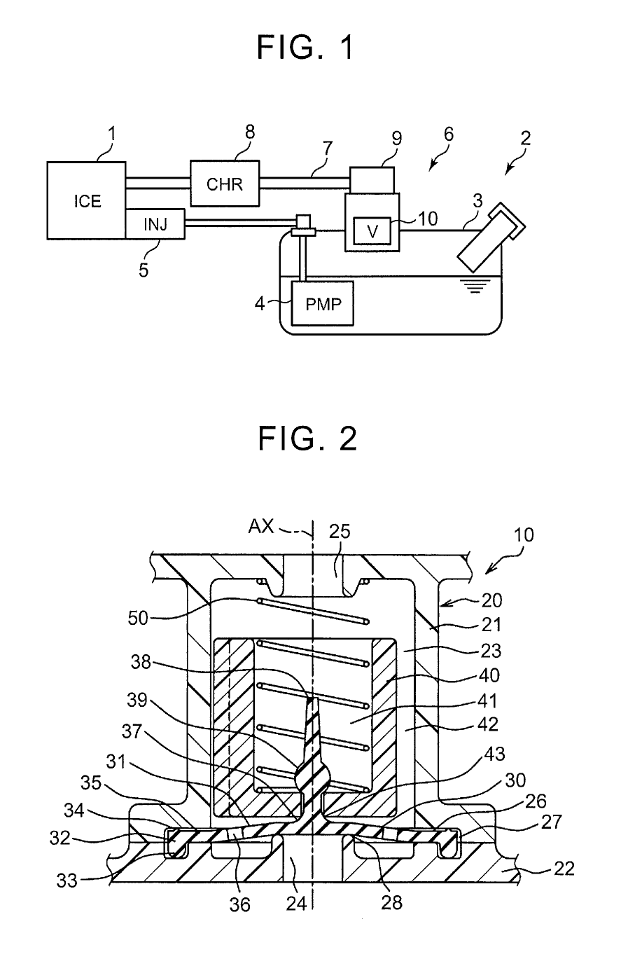

In FIG. 1, there is shown a fuel supply system 2 for an internal combustion engine (ICE) 1 mounted on a vehicle. The internal combustion engine 1 is a power source for a road vehicle. The fuel supply system 2 includes a tank 3 storing liquid fuel such as gasoline. The fuel supply system 2 includes a pressurizing device (PMP) 4 configured to suck and pressurize the fuel in the tank 3. The pressurizing device 4 is provided by, for example, an electric fuel pump. The fuel supply system 2 includes an injection device (INJ) 5 configured to supply the fuel pressurized by the pressurizing device 4 to the internal combustion engine 1. The injection device 5 is provided by, for example, an injector that can be actuated electromagnetically. The fuel supply system 2 includes a fuel vapor system 6.

The fuel vapor system 6 is a system configured to deal with a gas containing fuel vapor generated in the tank 3. The fuel vapor system 6 stores the fuel vapor generated in the tank 3. Further, the fuel vapor system 6 supplies the fuel vapor generated in the tank 3 and the stored fuel vapor to the internal combustion engine 1, thereby suppressing emission of the fuel vapor to the atmosphere. The fuel vapor system 6 is also called a fuel vapor treatment system, a tank ventilation system, or a canister system.

The fuel vapor system 6 includes a passage 7 for the gas containing the fuel vapor to flow through. The passage 7 extends between the tank 3 and an intake passage of the internal combustion engine 1. The passage 7 includes a branch passage for communication with the atmosphere, and so on. The passage 7 is provided by a plurality of members and a plurality of pipes.

The fuel vapor system 6 includes a canister (CHR) 8. The canister 8 is disposed in the passage 7. The canister 8 contains activated charcoal that serves to adsorb the fuel vapor. The canister 8 is also called a charcoal canister or a fuel vapor capturer. The canister 8 captures and stores the fuel vapor discharged from the tank 3. The canister 8 releases the stored fuel vapor and supplies it to the internal combustion engine 1. The canister 8 has a passage switching mechanism for switching between a capture mode and a release mode. The passage switching mechanism is provided by a solenoid valve that can be actuated electromagnetically. The passage 7 provides an introduction passage communicating between the tank 3 and the canister 8 and a discharge passage communicating between the canister 8 and the internal combustion engine 1.

The fuel vapor system 6 includes a passage controller 9 disposed between the tank 3 and the canister 8. The passage controller 9 is disposed in the passage 7. The passage controller 9 opens and closes the passage 7 in response to various conditions. In response to various conditions, the passage controller 9 controls the state of communication between the tank 3 and the canister 8 to various states including open and closed states. For example, the passage controller 9 opens and closes the passage 7 so as to suppress the outflow of the liquid fuel from the tank 3 into the passage 7. For example, the passage controller 9 opens and closes the passage 7 so as to introduce the air into the tank 3 in response to a lowering of the liquid surface in the tank 3. For example, the passage controller 9 opens and closes the passage 7 so as to discharge the air in the tank 3 in response to a rise of the liquid surface in the tank 3 during refueling. For example, the passage controller 9 opens and closes the passage 7 so as to keep the pressure in the tank 3 within a predetermined range.

The passage controller 9 has at least a pressure control function to control the pressure in the tank 3. The passage controller 9 includes at least a valve device (V) 10 configured to provide the pressure control function. The valve device 10 is disposed in the passage 7. The valve device 10 is disposed in direct communication with the tank 3. The valve device 10, solely by itself, can establish communication between the tank 3 and the passage 7. The valve device 10 establishes communication between the tank 3 and the passage 7 when the pressure in the tank 3 exceeds a predetermined threshold pressure. The valve device 10 is also called a relief valve. The valve device 10 is a valve that is not configured to be actuated electromagnetically, but is configured to open and close in response to only a pressure difference acting on a valve body thereof.

By opening of the valve device 10, the air containing fuel vapor in the tank 3 is supplied to the canister 8 through the passage 7. By closing of the valve device 10, the tank 3 is sealed off. When the valve device 10 is in the valve closed state, there are cases where the state of communication between the tank 3 and the passage 7 is controlled by other functions of the passage controller 9.

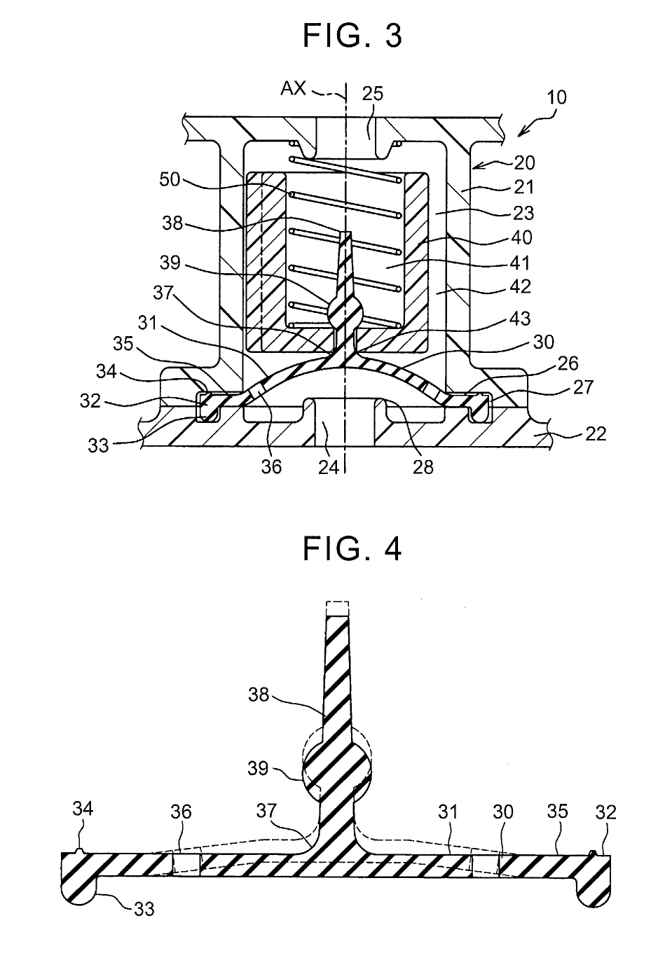

FIG. 2 shows the valve closed state of the valve device 10. FIG. 3 shows the valve open state of the valve device 10. In the following description, a moving direction of a movable valve of the valve device 10 will be referred to as an axial direction. In the figures, the axial direction is a direction along an axis AX. The axial direction corresponds to an up-down direction in a state where the vehicle is stopped on a level ground, i.e. the gravity direction. A direction perpendicular to the axial direction will be referred to as a radial direction.

The valve device 10 includes a case 20. The case 20 is made of resin. The case 20 defines therein a housing chamber housing the movable valve and provides a valve seat. The case 20 has an upper case 21 defining the housing chamber therein. The case 20 has a lower case 22 providing the valve seat. The upper case 21 and the lower case 22 are joined together by any of various joining structures such as welding that causes melting of the material, bonding using an adhesive, and fastening using bolts and so on. The upper case 21 has a hollow cylindrical portion and defines a chamber 23 therein. The lower case 22 provides a cover covering the chamber 23. Accordingly, the chamber 23 is defined by the upper case 21 and the lower case 22.

The lower case 22 defines and forms an inlet opening 24 communicating between the inside of the tank 3 and the inside of the chamber 23. The inlet opening 24 communicates directly with the inside of the tank 3, not through another valve device. The inlet opening 24 is opened to a lower surface of the chamber 23. The upper case 21 defines and forms an outlet opening 25 communicating between the inside of the chamber 23 and the passage 7. The outlet opening 25 communicates directly with the passage 7, not through another valve device. The outlet opening 25 is opened to an upper surface of the chamber 23.

The case 20 has an annular slit 26 and an annular chamber 27 for holding the movable valve which will be described later. The annular slit 26 and the annular chamber 27 are defined and formed between the upper case 21 and the lower case 22. In order to form the annular slit 26 and the annular chamber 27, the upper case 21 and the lower case 22 have annular grooves on their mating surfaces.

The annular slit 26 is formed so as to surround the chamber 23 over the entire circumference at a lower portion thereof. The annular slit 26 faces and communicates with the chamber 23. The annular slit 26 extends radially outward from the chamber 23.

The annular chamber 27 is located so as to be spaced radially outward from the chamber 23. The annular chamber 27 is also formed so as to surround the chamber 23 over its entire circumference. The annular chamber 27 is disposed on the radially outer side of the annular slit 26. The annular chamber 27 extends out in at least one direction in the axial direction from the annular slit 26. The axial height of the annular chamber 27 is greater than the axial height of the annular slit 26. It can also be said that the annular chamber 27 is deeper than the annular slit 26 along the axial direction. The annular chamber 27 is defined mainly by the annular groove formed on the lower case 22.

The case 20 has a valve seat 28. The valve seat 28 is formed so as to extend out tubularly from an inner surface of the lower case 22. The valve seat 28 is disposed so as to surround the inlet opening 24 over its entire circumference. The valve seat 28 is provided by a tubular portion extending out in the axial direction toward the inside of the chamber 23 from a surface, around the valve seat 28, of the lower case 22. The valve seat 28 extends out in the axial direction higher than an inner surface, defining the annular slit 26, of the lower case 22. A top end of the tubular portion providing the valve seat 28 is formed as a smooth curved surface. Accordingly, the valve seat 28 has a partial surface of a torus. The valve seat 28 functions as a valve by contacting and separating from a later-described umbrella valve. The valve seat 28 provides a stationary valve body.

The valve device 10 includes an umbrella valve 30 as the movable valve. The umbrella valve 30 is made of rubber. The umbrella valve 30 can be provided by a resin or the like having elasticity. The umbrella valve 30 can also be called a diaphragm valve. It can be said that the case 20 forms the chamber 23 housing the umbrella valve 30. The annular slit 26 and the annular chamber 27 extend annularly so as to surround the umbrella valve 30.

The umbrella valve 30 has a valve portion 31. The valve portion 31 is formed in a circular shape. The valve portion 31 is in the form of a plate having substantially a uniform thickness. The valve portion 31 presents the shape of a flat plate in a natural state. The valve portion 31 is elastically deformable in the axial direction. The valve portion 31 provides a movable valve body. The valve portion 31 provides a valve in cooperation with the valve seat 28. The valve portion 31 provides a valve closed state by contacting the valve seat 28. The valve portion 31 provides a valve open state by rising from the valve seat 28 in the axial direction to separate from the valve seat 28.

The umbrella valve 30 has an outer edge portion 32. The outer edge portion 32 is formed on the radially outer side of the valve portion 31. The outer edge portion 32 surrounds the valve portion 31 over its entire circumference. The outer edge portion 32 is restrained by the case 20 at least in the radial direction. The outer edge portion 32 is received in the annular slit 26 and the annular chamber 27. The outer edge portion 32 is held in the annular slit 26 and the annular chamber 27. The outer edge portion 32 is fitted into the annular slit 26 and/or the annular chamber 27 in order to prevent the outer edge portion 32 from coming off radially inward from the annular slit 26 and the annular chamber 27.

The outer edge portion 32 has a lower seal portion 33 disposed in the annular chamber 27. The lower seal portion 33 is formed at one side surface in the axial direction of the outer edge portion 32. The lower seal portion 33 extends annularly. The lower seal portion 33 extends out downward along the axial direction in the annular chamber 27. The lower seal portion 33 radially engages the annular chamber 27. Consequently, the lower seal portion 33 prevents the outer edge portion 32 from coming off radially inward.

The lower seal portion 33 provides a surface corresponding to a part of a torus. The lower seal portion 33 can also be called an annular protrusion. By contacting a surface, defining the annular chamber 27, of the lower case 22, the lower seal portion 33 provides airtightness between the umbrella valve 30 and the lower case 22. Consequently, a chamber is defined and formed between the umbrella valve 30 and the lower case 22.

The outer edge portion 32 has an upper seal portion 34 disposed in the annular slit 26 and/or the annular chamber 27. The upper seal portion 34 is formed at the other side surface in the axial direction of the outer edge portion 32. The upper seal portion 34 is disposed on the side opposite to the lower seal portion 33. The upper seal portion 34 extends annularly. The upper seal portion 34 extends out upward along the axial direction in the annular chamber 27.

The upper seal portion 34 provides a surface corresponding to a part of a torus. The upper seal portion 34 can also be called an annular protrusion. By contacting a surface, defining the annular slit 26 and/or the annular chamber 27, of the upper case 21, the upper seal portion 34 provides airtightness between the umbrella valve 30 and the upper case 21. Consequently, a chamber is defined and formed between the umbrella valve 30 and the upper case 21. The axial height of the upper seal portion 34 is smaller than the axial height of the lower seal portion 33.

The outer edge portion 32 has a restraint portion 35. The restraint portion 35 is located radially inward of the lower seal portion 33 and the upper seal portion 34. The restraint portion 35 is located in the annular slit 26. The moving amount of the restraint portion 35 in the axial direction is limited in the annular slit 26. The restraint portion 35 can move in the axial direction only by a limited amount in the annular slit 26. Accordingly, it can be said that the outer edge portion 32 has the restraint portion 35 received in the annular slit 26 and the seal portion (the lower seal portion 33, the upper seal portion 34) extending out in the axial direction from the restraint portion 35 and received in the annular chamber 27. The lower seal portion 33 extends out in the axial direction in the annular chamber 27, thereby preventing the outer edge portion 32 from moving radially inward.

The umbrella valve 30 has a plurality of passage openings 36. The passage openings 36 are formed through the valve portion 31. The passage openings 36 are located radially outward of the valve seat 28. The passage openings 36 are dispersively arranged so as to surround the valve seat 28. The passage openings 36 communicate between an annular first downstream chamber, defined and formed between the valve portion 31 and the lower case 22, and a second downstream chamber defined and formed between the valve portion 31 and the upper case 21. The passage openings 36 allow communication between the inlet opening 24 and the outlet opening 25 in the valve open state. The passage openings 36 allow a gas containing fuel vapor to flow through.

The umbrella valve 30 has a projecting portion 37 at a central portion of the valve portion 31. The projecting portion 37 is formed on an upper side of the valve portion 31, i.e. at a surface, facing the upper case 21, of the valve portion 31. The projecting portion 37 is trapezoidal in section. The projecting portion 37 has a shape that can be called a circular truncated cone. The outer diameter of the projecting portion 37 is smaller than the inner diameter of the valve seat 28. The outer diameter of the projecting portion 37 is smaller than the inner diameter of the inlet opening 24. The outer diameter of the projecting portion 37 is smaller than the diameter of a contact portion between the valve portion 31 and the valve seat 28.

The umbrella valve 30 has a plug portion 38 for coupling to a later-described retainer 40. The plug portion 38 extends out upward along the axial direction from the center of the valve portion 31. The projecting portion 37 is formed at the base of the plug portion 38. The projecting portion 37 is formed between the plug portion 38 and the valve portion 31. The plug portion 38 has a stopper portion 39 for coupling together the plug portion 38 and the retainer 40. The stopper portion 39 is formed a little bigger around than the other portion of the plug portion 38.

The valve device 10 has the retainer 40. The retainer 40 is housed in the chamber 23. The retainer 40 is displaceable in the axial direction in the chamber 23. The retainer 40 has an outer diameter smaller than the inner diameter of the chamber 23. The retainer 40 is coupled to the umbrella valve 30. The retainer 40 is made of resin. The retainer 40 is formed in a shape that can be called a bottomed cylindrical shape or a cup shape. The retainer 40 defines therein an inner chamber 41 by its tubular outer wall and its bottom wall. The retainer 40 defines a plurality of outer grooves 42 on an outer surface of the tubular outer wall. The outer grooves 42 are arranged at regular intervals on the outer surface of the retainer 40. The retainer 40 defines and forms a through hole 43 in the bottom wall.

The outer grooves 42 provide passages for the air containing fuel vapor. The through hole 43 can receive therethrough the plug portion 38 and the stopper portion 39. The through hole 43 has an inner diameter large enough to allow the stopper portion 39 to pass through by elastically deforming the stopper portion 39. The inner diameter of an opening portion, facing the valve portion 31, of the through hole 43 is smaller than the outer diameter of an intermediate portion of the projecting portion 37. As a result, the retainer 40 is supported above the intermediate portion of the projecting portion 37. The retainer 40 is supported on an upper surface of the valve portion 31 so as not to be simultaneously brought into contact with the upper surface of the valve portion 31 over its entire circumference.

The valve device 10 has a spring 50. The spring 50 is disposed between the retainer 40 and the upper case 21. In other words, the retainer 40 is disposed between the spring 50 and the valve portion 31. The spring 50 presses the umbrella valve 30 and the retainer 40 downward in the axial direction. The spring 50 presses the valve portion 31 toward the valve seat 28. The spring 50 is a bias spring configured to press the umbrella valve 30 in a valve closing direction.

In this embodiment, the retainer 40 functions as a seat for the spring 50. The retainer 40 functions as a guide member for guiding the axial movement of the umbrella valve 30.

As shown in FIG. 2, when the valve device 10 is in the valve closed state, the umbrella valve 30 has a shape in which the valve portion 31 is slightly convex upward. In the valve closed state, the central portion of the valve portion 31 is slightly raised upward by the valve seat 28.

As shown in FIG. 3, when the valve device 10 is in the valve open state, the umbrella valve 30 has a shape in which the valve portion 31 is largely convex upward. In the valve open state, the valve portion 31 is raised by the pressure in the tank 3 so as to largely swell upward. The valve portion 31 is elastically deformed.

In FIG. 4, a solid line indicates a natural state of the umbrella valve 30, while a dashed line indicates the shape of the umbrella valve 30 in the valve closed state shown in FIG. 2. In the valve closed state, the umbrella valve 30 is placed in a slightly elastically deformed state. In other words, the umbrella valve 30 is given a preload and thus is pre-deformed in the valve closed state. The valve portion 31 is deformed from a flat plate to an upward convex curved plate. In this state, the umbrella valve 30 is restrained in the radial direction at the outer edge portion 32. Accordingly, the valve portion 31 is slightly stretched since its central portion is pushed out upward.

In the valve closed state, the umbrella valve 30 is pressed against the valve seat 28 due to its own elasticity. Further, the outer edge portion 32 formed on the radially outer side of the valve portion 31 is restrained in the axial direction by the case 20. Therefore, the valve portion 31 is pressed against the valve seat 28 so as to be wound around the valve seat 28 on the radially outer side of the valve seat 28. Consequently, a satisfactory contact state is obtained between the valve portion 31 and the valve seat 28 over the entire circumference in the circumferential direction of the valve seat 28.

A force of the spring 50 also acts on the umbrella valve 30. The central portion of the valve portion 31 is pressed downward by the spring 50. The force of the spring 50 acts only on the central portion of the valve portion 31 due to the retainer 40 and the projecting portion 37. Further, the force of the spring 50 acts only on the inner side than the valve seat 28. Therefore, the valve portion 31 is pressed against the valve seat 28 so as to be wound around the valve seat 28 on the radially inner side of the valve seat 28. Consequently, a satisfactory contact state is obtained between the valve portion 31 and the valve seat 28 over the entire circumference in the circumferential direction of the valve seat 28.

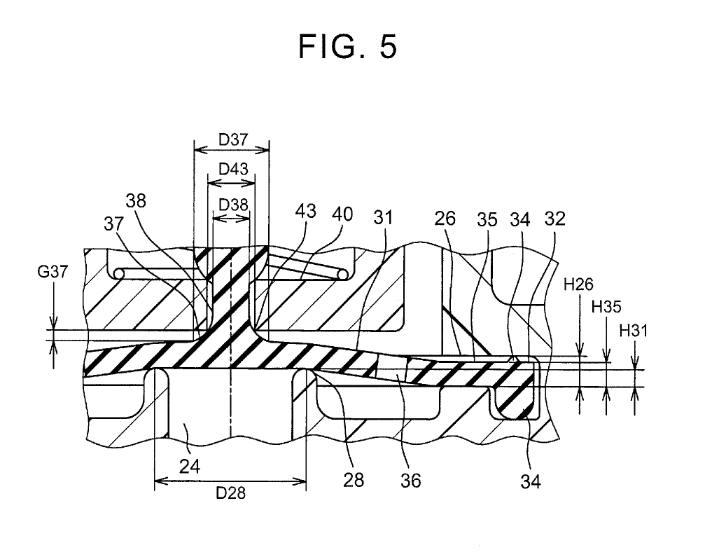

In FIG. 5, there are shown the dimensions of the respective portions of the case 20 and the umbrella valve 30. A height H26 in the axial direction of the annular slit 26 is slightly greater than a thickness H35 in the axial direction of the restraint portion 35. The thickness H35 is also the thickness of the valve portion 31. The difference between the height H26 and the thickness H35 corresponds to the protrusion height of the upper seal portion 34. The restraint portion 35 can be slightly displaced in the axial direction between the valve closed state and the valve open state. This makes it possible to reduce stress concentration to the umbrella valve 30 at a radially inner corner portion of the annular slit 26.

An elastic deformation amount H31 in the axial direction of the valve portion 31 in the valve closed state depends on the projection height of the valve seat 28 with respect to the annular slit 26. The deformation amount H31 is smaller than the height H26. The deformation amount H31 is smaller than the thickness H35. Since the deformation amount H31 is smaller than the height 1126, contact between the radially inner corner portion of the annular slit 26 and the umbrella valve 30 is suppressed. In the valve closed state, the valve portion 31 is elastically deformed so as to be convex by a predetermined amount, i.e. the deformation amount 1131, in one direction in the axial direction. In the valve open state, the valve portion 31 is elastically deformed so as to be convex by greater than the predetermined amount in the one direction.

A diameter D28 of the valve seat 28 is greater than a maximum diameter D37 of the projecting portion 37. An inner diameter D43 of the through hole 43 is greater than a diameter D38 of the plug portion 38. The inner diameter D43 is smaller than the diameter D37. A corner portion of the through hole 43 contacts a conical surface provided by the projecting portion 37. In other words, the projecting portion 37 is partially inserted into the through hole 43 and contacts an opening end of the through hole 43. As a result, the projecting portion 37 forms a gap G37 in the axial direction between the retainer 40 and the valve portion 31. Since the corner portion of the through hole 43 contacts the projecting portion 37, the valve portion 31 is pressed in a seating direction radially inward of the valve seat 28. The retainer 40 contacts the valve portion 31 radially inward of the valve seat 28. Consequently, the retainer 40 causes the force of the spring 50 to act on the valve portion 31 radially inward of the valve seat 28.

According to this embodiment, the valve device 10 opens and closes the state of communication between the tank 3 and the passage 7 in response to a pressure difference between the pressure in the tank 3 and the pressure in the passage 7. The pressure in the passage 7 acts on a first surface, i.e. an upper surface, of the umbrella valve 30. The pressure in the tank 3 acts on a second surface, i.e. a lower surface, of the umbrella valve 30. The umbrella valve 30 receives the pressure of an inside of the tank 3 on its one surface and the pressure of an inside of the passage 7 on its other surface, thereby switching between a valve open state and a valve closed state in response to a pressure difference therebetween. The umbrella valve 30 provides a relief valve configured to relieve a gas containing fuel vapor from the tank 3 to the passage 7. Further, a bias force in a valve closing direction by the spring 50 acts on the umbrella valve 30.

When the valve device 10 is in the valve closed state, the pressure in the tank 3 acts on the lower surface of the umbrella valve 30 only in a circular range surrounded by the valve seat 28. When the valve device 10 is in the valve open state, the pressure in the tank 3 acts on substantially the entire lower surface of the umbrella valve 30. Therefore, hysteresis is given to switching from the valve closed state to the valve open state and switching from the valve open state to the valve closed state. For example, the pressure at which the valve device 10 is switched from the valve closed state to the valve open state is higher than the pressure at which the valve device 10 is switched from the valve open state to the valve closed state. This makes it possible to suppress frequent opening and closing of the valve device 10.

When the difference between the pressure in the tank 3 and the pressure in the passage 7 is smaller than a predetermined first threshold value, the valve portion 31 is seated on the valve seat 28. In this state, the pre-deformation of the valve portion 31 and/or the spring 50 provide stable contact between the valve portion 31 and the valve seat 28. For example, the lower surface of the valve portion 31 in an annular range is in contact with the valve seat 28.

When the difference between the pressure in the tank 3 and the pressure in the passage 7 exceeds the predetermined first threshold value, the valve portion 31 is displaced against the pressing force of the spring 50. Consequently, the valve portion 31 is separated from the valve seat 28. The valve portion 31 is elastically deformed. Since the umbrella valve 30 is restrained over its entire circumference, the valve portion 31 is raised in the axial direction in the state where its radial movement is suppressed.

By the separation of the valve portion 31 from the valve seat 28, the area in which the pressure in the tank 3 acts on the valve portion 31 increases. A gas in the tank 3 flows out into the passage 7 through the inlet opening 24, the passage openings 36, the chamber 23, and the outlet opening 25. The passage openings 36 function also as throttle passages. As a result, the pressure in the tank 3 gradually decreases. The gas in the tank 3 is supplied to the canister 8. The canister 8 captures and stores fuel vapor components. The stored fuel vapor components are released toward the intake passage when the internal combustion engine 1 is operated.

When the difference between the pressure in the tank 3 and the pressure in the passage 7 becomes smaller than a second threshold value that is smaller than the above-mentioned first threshold value, the valve portion 31 sits on the valve seat 28. Since the umbrella valve 30 is restrained over its entire circumference, the valve portion 31 contacts the valve seat 28 at the same position as in the valve closed state described above. As a result, even if the valve device 10 repeats opening and closing, the valve closed state is stably provided.

According to this embodiment, since the radial movement of the valve portion 31 is suppressed, even if the valve device 10 repeats opening and closing, the same region of the valve portion 31 stably contacts the valve seat 28. Further, since the valve portion 31 is restrained over its entire circumference, the inclination of the valve portion 31 is suppressed. Therefore, the valve portion 31 and the valve seat 28 ensure stable sealing therebetween over the entire circumference of the valve seat 28. Further, both in the valve closed state and in the valve open state, the valve portion 31 is elastically deformed so as to be convex in one direction, i.e. upward in the figures. Therefore, stable behavior of the valve portion 31 is obtained. Further, when the valve device 10 is in the valve open state, the elasticity of the valve portion 31 itself acts on the valve portion 31. Therefore, vibration behavior of the valve portion 31 is suppressed by its own elasticity. This makes it possible to obtain advantages such that the noise is suppressed, that the flow rate is stabilized, and that the durability is improved.

According to this embodiment, the umbrella valve 30 is seated on the valve seat 28 by its own elasticity and the pressing force of the spring 50. Therefore, it is possible to make sufficiently large a force to press the valve portion 31 against the valve seat 28. The valve portion 31 is pressed against the valve seat 28 by receiving the pressing force from the spring 50 radially inward of the valve seat 28. Further, the valve portion 31 is pressed against the valve seat 28 by its own elasticity due to being pre-deformed to be convex upward. As a result, it is possible to ensure reliable contact between the valve portion 31 and the valve seat 28. In this way, according to this embodiment, it is possible to provide the valve device 10 that can suppress leakage in the valve closed state.

### Other Embodiments

The invention disclosed herein is by no means limited to an embodiment for carrying out the invention and can be carried out with various changes. The disclosed invention is not limited to a combination shown in the embodiment and can be carried out in various combinations. The embodiment can have an additional portion. A portion of the embodiment may be omitted. A portion of the embodiment may be replaced or combined with a portion of another embodiment. The structure, operation, and effect of the embodiment are by way of example only. The technical scope of the disclosed invention is not limited to a description of the embodiment. It is to be understood that some technical scopes of the disclosed invention are shown by a description of the claims and further include all changes within the meaning and range of the description of the claims and equivalents thereof.

In the above-described embodiment, the passages in the valve open state are provided by the passage openings 36 penetrating the valve portion 31. Instead of this, a passage opening corresponding to the outlet opening 25 may be formed in the lower case 22 radially outward of the valve seat 28 without forming the passage openings 36 in the valve portion 31.

In the above-described embodiment, the upper seal portion 34 is provided by the annular protrusion smaller than the lower seal portion 33. Instead of this, the lower seal portion 33 may be formed to be smaller than the upper seal portion 34. Alternatively, the lower seal portion 33 and the upper seal portion 34 may be formed in the same size. In this case, the outer edge portion 32 is formed in a low tubular or torus shape protruding upward and downward.

In the above-described embodiment, the umbrella valve 30 and the retainer 40 are coupled together by the plug portion 38 formed in the umbrella valve 30. Instead of this, the umbrella valve 30 and the retainer 40 may be coupled together by coupling together a through hole or a plug hole formed at the center of the valve portion 31 and a projection formed to project from the retainer 40.

In the above-described embodiment, the deep cup-shaped retainer 40 is employed and the function as a spring guide is given to the retainer 40. Instead of this, a shallow dish-shaped retainer may be employed. In the above-described embodiment, the force of the spring 50 is caused to act on the central portion of the valve portion 31 by forming the projecting portion 37 on the valve portion 31. Instead of this, the retainer 40 may be formed with an annular projecting portion corresponding to the projecting portion 37. Instead of the spring 50, a tapered spring that can suppress tilting may be employed. The valve portion 31 may be biased in the valve closing direction solely by the elasticity of the umbrella valve 30 without using the spring 50. Even with the configuration described above, it is possible to provide an improvement in the stability of the position of the valve portion 31, suppression of vibration of the valve portion 31, and stable contact between the valve portion 31 and the valve seat 28.

What is claimed is:

1. A valve device, disposed in a passage for a gas containing fuel vapor to flow through, for a fuel vapor system, the valve device comprising:
a case having a valve seat; and
an umbrella valve having a valve portion that is elastically deformable in an axial direction, provides a valve closed state by contacting the valve seat, and provides a valve open state by separating from the valve seat, and an outer edge portion that is formed on a radially outer side of the valve portion and restrained by the case, wherein:
the valve portion is elastically deformed so as to be convex by a predetermined amount in one direction in the axial direction in the valve closed state; and
the valve portion is elastically deformed so as to be convex by greater than the predetermined amount in the one direction in the valve open state.

2. The valve device according to claim 1, wherein:
the case forms a chamber housing the umbrella valve and has an annular slit extending annularly so as to surround the umbrella valve and facing the chamber and an annular chamber formed on a radially outer side of the annular slit; and
the outer edge portion has a restraint portion received in the annular slit and a seal portion extending out in the axial direction from the restraint portion and received in the annular chamber.

3. The valve device according to claim 2, wherein:
the annular chamber extends out in at least one direction in the axial direction from the annular slit; and
the seal portion extends out in the axial direction in the annular chamber, thereby preventing the outer edge portion from moving radially inward.

4. The valve device according to claim 1, further comprising:
a spring configured to press the valve portion toward the valve seat; and
a retainer disposed between the spring and the valve portion, wherein:
the retainer contacts the valve portion radially inward of the valve seat, thereby causing a force of the spring to act on the valve portion radially inward of the valve seat.

5. The valve device according to claim 4, wherein:
the retainer has a through hole; and
the valve portion has a projecting portion that is partially inserted into the through hole and contacts an opening end of the through hole, thereby forming a gap between the retainer and the valve portion.

6. The valve device according to claim 1, wherein:
the umbrella valve has a passage opening formed through the valve portion for allowing the gas containing fuel vapor to flow through.

7. The valve device according to claim 1, wherein:
the umbrella valve receives a pressure of an inside of a tank storing fuel on one surface thereof and a pressure of an inside of the passage of the fuel vapor system on the other surface thereof, thereby switching between the valve open state and the valve closed state in response to a pressure difference therebetween.

8. The valve device according to claim 7, wherein:
the umbrella valve is a relief valve configured to relieve the gas containing fuel vapor from the tank to the passage.
